(19) United States
(12) Patent Application Publication
(10) Pub. No.: US 2014/0063228 A1
(43) Pub. Date: Mar. 6, 2014

(54) METHOD AND SYSTEM FOR CLEANING SURFACES AND NON-DESTRUCTIVE INSPECTION THEREOF

(71) Applicants: Justin Carl Boles, Gloversville, NY (US); Edward Lee Bentzel, Acworth, GA (US); Edward Barrett Hubben, Skaneateles, NY (US); Thomas Earnest Moldenhauer, Burnt Hills, NY (US)

(72) Inventors: Justin Carl Boles, Gloversville, NY (US); Edward Lee Bentzel, Acworth, GA (US); Edward Barrett Hubben, Skaneateles, NY (US); Thomas Earnest Moldenhauer, Burnt Hills, NY (US)

(73) Assignee: GENERAL ELECTRIC COMPANY, Schenectady, NY (US)

(21) Appl. No.: 13/605,709

(22) Filed: Sep. 6, 2012

(51) Int. Cl. H04N 7/18

(52) U.S. Cl. 348/82; 348/E07.085

(57) ABSTRACT

An inspection system and methods for remote cleaning and inspection of difficult to access components within complex machinery. The system includes a display screen, a video borescope coupled to the display screen, an insertion tube, a camera head disposed at a distal end of the insertion tube, a feature for capturing an image and/or video with the camera head and displaying the image and/or video on the display screen, and a feature for remotely steering the distal end of the insertion tube as well as a nozzle of a feed tube that is attached to the insertion tube and adapted to apply a cleaning fluid to a surface to be inspected.

### BACKGROUND OF THE INVENTION

The present invention generally relates to inspection equipment and methods. More particularly, this invention relates to insertion tube devices configured for inspecting complex hardware, for example, of gas turbines.

Remote inspection of hard to access locations is a growing problem in the power generation industry. Components located within complex machinery, such as gas turbines and other turbomachinery, must be inspected regularly to prevent failure due to the harsh environments in which they operate. Gas turbine components are often visually inspected using a borescope or similar device.

A borescope is generally characterized as an elongated insertion tube which can be flexible with a viewing head at its distal or forward end. The viewing head may be equipped with, for example, a camera head assembly, that provides the operator of the borescope with a remote viewing capability. Borescopes are typically adapted to be maneuvered through narrow tortuous passageways, and therefore their insertion tubes are flexible and must allow corresponding bending and steering. For this purpose, a borescope typically includes a bendable tube steering section or articulation section at or near its distal end adjacent to the viewing head, and a control housing at its proximal end for controlling or steering the viewing head. One or more pairs of control articulation cables typically extend from the articulation section and connect with a steering control at the control housing, with which the cables can be differentially displaced to bend the articulation section. The viewing camera head assembly can thus be remotely oriented to facilitate the visual inspection of an object. As a nonlimiting example, FIG. 1 represents a borescope 10 of a type known in the art and comprising a flexible insertion tube 12, a camera head assembly 14 disposed at an articulating distal end 18 of the tube 12, a hand unit 16 disposed at a proximal end of the tube 12, and a display screen 20 adapted to display an image and/or video captured by the camera head assembly 14. The hand unit 16 is equipped with controls 22 by which movement of the camera head assembly 14 can be remotely controlled by a user.

Borescopes have been found to be particularly useful for visual inspection of large machinery, including gas turbines and other turbomachines whose internal components would be difficult or impossible to directly examine without disassembling the machine. Pathways to internal components of turbomachines can be quite long, and it is often necessary that the insertion tube of a borescope have a length of fifteen meters or more.

In order to perform non-destructive inspect of an internal component within a turbomachine, the surfaces of the component must be relatively clean and free from heavy corrosion and contamination. Unfortunately, internal components of turbomachines are difficult to clean due to their remote locations and the long and tortuous pathways often required to reach the components within the turbomachine.

In view of the above, it can be appreciated that there are certain problems, shortcomings or disadvantages associated with inspecting internal components of complex machinery, and that it would be desirable if equipment and methods were available that enabled remote cleaning and inspection of difficult to access components.

### BRIEF DESCRIPTION OF THE INVENTION

The present invention provides methods and systems suitable for remote cleaning and inspection of difficult to access components within complex machinery, including but not limited to gas turbines and other turbomachinery.

According to a first aspect of the invention, an inspection system is provided that includes a display screen, a video borescope coupled to the display screen, an insertion tube having a distal end relative to the display screen, a camera head disposed on the distal end of the insertion tube, means for capturing an image and/or video with the camera head and displaying the image and/or video on the display screen, and means of remotely steering the distal end of the insertion tube. A feed tube is physically coupled to the insertion tube and is fluidically coupled to a source of a cleaning fluid. The feed tube has a distal end relative to the source and a nozzle disposed at the distal end of the feed tube. The feed tube is adapted to apply the cleaning fluid to a surface to be inspected with the borescope. The feed tube is physically coupled to the insertion tube so that the steering means of the borescope simultaneously steers the distal end of the feed tube.

According to a second aspect of the invention, a method is provided for cleaning and inspecting a surface within a complex machine. The method includes inserting at least one tube into the machine and feeding the at least one tube through a pathway into an interior of the machine. The at least one tube is remotely steered around obstacles in the pathway. A distal end of the at least one tube is positioned at a location near the surface within the machine and the surface is cleaned with a cleaning fluid delivered to the surface via the at least one tube. A non-destructive inspection of the surface is performed with the at least one tube.

A technical effect of the invention is the ability of the inspection system to perform both remote cleaning and inspection of component surfaces that are difficult to access within a machine, and might otherwise require partial disassembly of the machine in order to gain access to the component and its surface.

Other aspects and advantages of this invention will be better appreciated from the following detailed description.

### BRIEF DESCRIPTION OF THE DRAWINGS

FIG. 1 represents a borescope of a type known in the art.

FIG. 2 schematically represents a plan view of an inspection system in accordance with an aspect of the present invention.

### DETAILED DESCRIPTION OF THE INVENTION

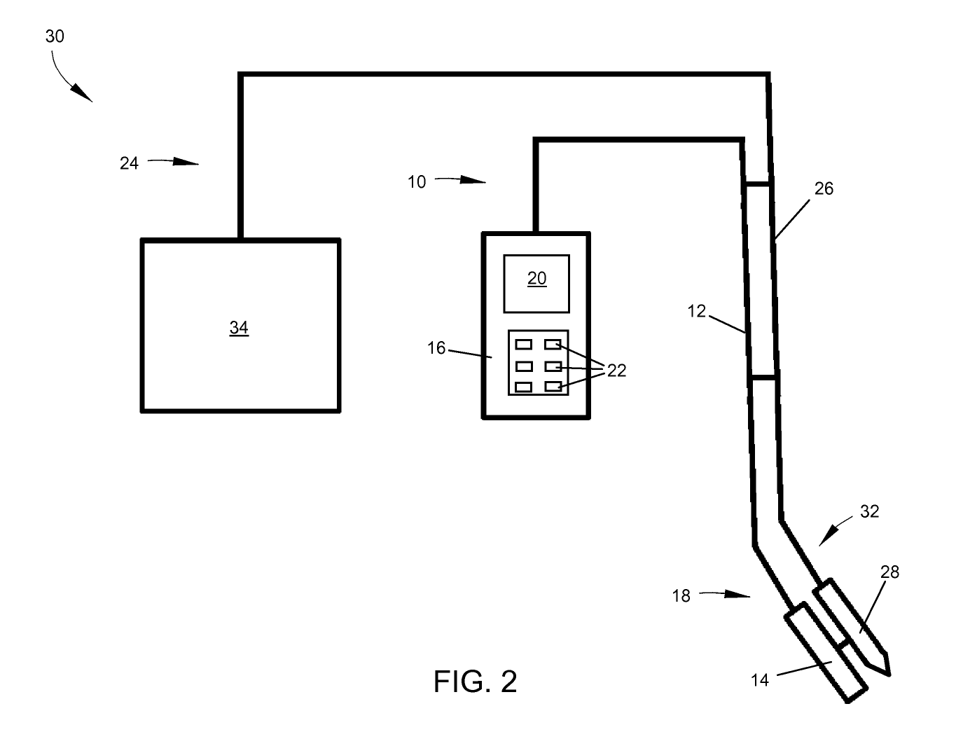

FIG. 2 schematically represents an inspection system 30 suitable for use in the present invention. The inspection system 30 is schematically represented as including a borescope system comprising a video borescope 10 adapted for visually inspecting surfaces. The borescope 10 may be of any construction capable of visually inspecting surfaces, but in preferred embodiments is particularly adapted for inspecting surfaces that are not directly or readily accessible. Notable but nonlimiting examples include surfaces of internal components within gas turbines and other complex machines, including gas turbine engines used in the power generation industry, that would not be directly or readily accessible unless the machines are at least partially disassembled. The borescope 10 is further represented in FIG. 2 as being associated with a cleaning system 24 adapted for cleaning surfaces to be inspected with the borescope 10.

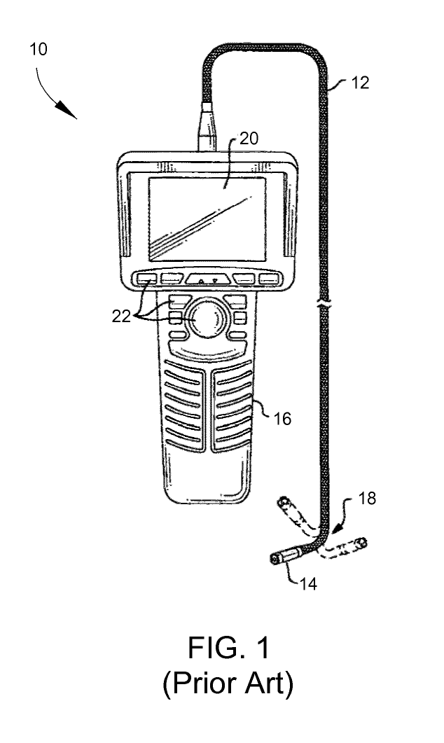

For purposes of this disclosure, the borescope 10 will be described as being similar or equivalent to the borescope 10 represented in FIG. 1, and therefore the same reference numbers will be used in FIG. 2 to identify similar or equivalent features identified for the borescope 10 of FIG. 1. As such, FIG. 1 represents the borescope 10 as comprising an insertion tube 12 that includes a camera head assembly 14 at an articulating end 18 of the tube 12 that is distal to a hand unit 16. The camera head assembly 14 contains optical viewing components (not shown) that are capable of capturing an image and/or video of a surface adjacent a lens assembly of the camera head assembly 14. The borescope 10 includes a means of transferring images of the inspected surface from the camera head assembly 14 through the insertion tube 12 to be displayed on a display screen 20 for viewing by a user. This may be accomplished by transferring the image by cable wiring, including flexible electrical conductors, throughout the length of the insertion tube 12, though other means capable of transferring an image are also within the scope of the invention. The borescope 10 preferably has means for remotely controlling the position of, that is, steering, the camera head assembly 14. For example, an articulation cable assembly (not shown) within the insertion tube 12 can be used in combination with a control servomotor (not shown), which preferably cooperate to articulate at least the distal end 18 of the insertion tube 12. Such movements can be remotely controlled by a user with controls 22 provided on the hand unit 16.

The camera head assembly 14, in addition to having means of capturing images and/or video, can have an illumination system for lighting the surface to be inspected. As known in the art, illumination can be accomplished by including fiber optic bundles or light emitting diodes within the camera head assembly 14, though other illumination techniques are also foreseeable.

According to an aspect of the invention, the insertion tube 12 of the borescope 10 is physically coupled to a small diameter, flexible, low-temperature-capable feed tube 26 that forms part of the cleaning system 24. The feed tube 26 is adapted to transfer a fluid from a source 34 of a cleaning fluid to be applied to surfaces to be inspected with the borescope 10. The feed tube 26 has a distal end 32 equipped with a nozzle 28 that is preferably small and tapered for controlling the flow from the feed tube 26 to the inspected surface. The nozzle 28 of the feed tube 26 can be directly coupled to the camera head assembly 14 of the insertion tube 12. The feed tube 26 may be attached externally to the insertion tube 12, in either a removable or permanent manner, or disposed within the insertion tube 26. Preferably, the feed tube 26 is attached in a removable manner to allow the feed tube 26 to be replaced should another type of cleaning fluid and source 34 be desired.

The source 34 may be of any suitable type or construction capable of supplying the desired cleaning fluid to a surface to be inspected. For example, the source 34 can be an air cylinder, a low pressure compressed air supply, or a compressor (electric or gas). Cleaning fluid that is supplied by the source 34 may be, as used herein, a gas, liquid, solution, solid suspended in a liquid or gas, or any other medium capable of cleaning the surface to be inspected. For example, the cleaning fluid may be a mixture of nitrogen and oxygen (e.g., air), water, nitrogen, carbon dioxide, or inert gases such as helium or argon. In a preferred embodiment, the source 34 is a standard dry ice (CO₂) blasting system that is modified to deliver dry ice shavings entrained in a pressurized air stream. Preferably, the cleaning fluid utilized leaves little or no residue and does not require the use of a solvent to clean the surface to be inspected after application of the cleaning fluid.

The insertion tube 12 and feed tube 26 may be inserted through an inspection port or void provided or present in a machine that is intended for or otherwise enables access to surfaces of internal components of the machine that are to be inspected with the inspection system 30. As the insertion tube 12 and feed tube 26 are fed through this port or void, the remote visual and mechanical articulation capability of the borescope 10 and its insertion tube 12 are used to simultaneously direct or steer the camera head assembly 14 and nozzle 28 around any obstacles along the pathway to the surfaces to be inspected. As such, the borescope 10 provides aiming and steering capabilities for the entire inspection system 30, including the means for delivering the nozzle 28 of the feed tube 26 to internal areas of a machine.

Once the distal ends 18 and 32 of the insertion and feed tubes 12 and 26 have reached a location near a surface to be inspected, the inspection system 30 may be used to prepare the surface for various nondestructive inspections. Surface preparation may involve remotely cleaning surface contaminants, for example, deposits, corrosion products and/or residue, from the surface to be inspected by activating the source 34 to transfer the cleaning fluid through the feed tube 26 to the surface, such that the surface is impinged by the cleaning fluid in a manner that will sufficiently remove the surface contaminants to permit visual inspection with the borescope 10.

After surface preparation is complete, the borescope 10 may be used in performing nondestructive inspections of the surface such as remote visual inspection, fluorescent penetrant inspection, or any other type of inspection for which the borescope 10 is adapted to perform.

While the invention has been described in terms of a preferred embodiment, it is apparent that other forms could be adopted by one skilled in the art. For example, the physical configuration of the inspection system 30 could differ from that shown, and materials and processes other than those noted could be used. Therefore, the scope of the invention is to be limited only by the following claims.

1. An inspection system comprising:
a display screen;
a video borescope coupled to the display screen and comprising an insertion tube having a distal end relative to the display screen, a camera head disposed on the distal end of the insertion tube, means for capturing an image and/or video with the camera head and displaying the image and/or video on the display screen, and means of remotely steering the distal end of the insertion tube; and
a feed tube physically coupled to the insertion tube, the feed tube being fluidically coupled to a source of a cleaning fluid and having a distal end relative to the source and a nozzle disposed at the distal end of the feed tube and adapted to apply the cleaning fluid to a surface to be inspected with the borescope, the feed tube being physically coupled to the insertion tube so that the steering means of the borescope simultaneously steers the distal end of the feed tube.

2. The inspection system of claim 1, wherein the feed tube is externally attached to the insertion tube.

3. The inspection system of claim 1, wherein the feed tube is removably attached to the insertion tube.

4. The inspection system of claim 1, wherein the feed tube is disposed within the insertion tube.

5. The inspection system of claim 1, wherein the nozzle of the feed tube is coupled to the camera head of the insertion tube.

6. The inspection system of claim 1, wherein the cleaning fluid comprises a gas chosen from the group consisting of oxygen, nitrogen, carbon dioxide, helium, argon, and mixtures thereof.

7. The inspection system of claim 1, wherein the cleaning fluid comprises dry ice shavings entrained in pressurized air.

8. The inspection system of claim 1, wherein the borescope is adapted to perform a visual inspection of the surface with the camera head.

9. The inspection system of claim 1, wherein the borescope is adapted to perform a fluorescent penetrant inspection of the surface.

10. A method of cleaning and inspecting a surface within a complex machine, the method comprising:
inserting at least one tube into the machine and feeding the at least one tube through a pathway into an interior of the machine;
remotely steering the at least one tube around obstacles in the pathway;
positioning a distal end of the at least one tube at a location near the surface within the machine;
cleaning the surface with a cleaning fluid delivered to the surface via the at least one tube; and then
performing a non-destructive inspection of the surface with the at least one tube.

11. The method of claim 10, wherein the at least one tube comprises an insertion tube and a feed tube externally attached to the insertion tube.

12. The method of claim 11, wherein the feed tube is removably attached to the insertion tube.

13. The method of claim 11, wherein the feed tube is disposed within the insertion tube.

14. The method of claim 11, wherein the feed tube comprises a nozzle that is coupled to a distal end of the insertion tube.

15. The method of claim 10, wherein the cleaning fluid comprises a gas chosen from the group consisting of oxygen, nitrogen, carbon dioxide, helium, argon, and mixtures thereof.

16. The method of claim 10, wherein the cleaning fluid comprises dry ice shavings entrained in pressurized air.

17. The method of claim 10, wherein the non-destructive inspection comprises remotely performing a visual inspection of the surface with a camera head located at the distal end of the at least one tube.

18. The method of claim 10, wherein the non-destructive inspection comprises remotely performing a fluorescent penetrant inspection of the surface.

19. The method of claim 10, wherein the machine is a turbomachine, the at least one tube is inserted into the turbomachine through an inspection port thereof, and the surface is on an internal component of the turbomachine.

20. The method of claim 19, wherein the turbomachine is a gas turbine engine used for power generation.

21. A method of cleaning and inspecting a surface within a complex machine using the inspection system of claim 1, the method comprising:
inserting the insertion and feed tubes into the machine and feeding the insertion and feed tubes through a pathway into an interior of the machine;
remotely steering the insertion and feed tubes around obstacles in the pathway;
positioning the distal ends of the insertion and feed tubes at a location near the surface within the machine;
cleaning the surface with a cleaning fluid delivered to the surface via the feed tube; and then
performing a non-destructive inspection of the surface with the insertion tube.
